(19) United States
(12) Patent Application Publication
(10) Pub. No.: US 2003/0003021 A1
(43) Pub. Date: Jan. 2, 2003

(54) Parallel reactor system and method

(75) Inventors: Martin P. McGrath, Webster Groves, MO (US); James P. Coleman, Maryland Heights, MO (US); Robert C. Elliott, St. Louis, MO (US)

Correspondence Address: JENKENS & GILCHRIST, A PROFESSIONAL CORPORATION, 1100 LOUISIANA, SUITE 1800, HOUSTON, TX, 77002-5214, US

(73) Assignee: Monsanto Technology LLC, St. Louis, MO

(21) Appl. No.: 10/163,775

(22) Filed: Jun. 5, 2002

Related U.S. Application Data
(60) Provisional application No. 60/296,357, filed on Jun. 6, 2001.

(51) Int. Cl. B01J 19/00

(52) U.S. Cl. 422/99; 422/102; 422/130; 422/131

(57) ABSTRACT

A parallel reactor system and method therefor are disclosed. The parallel reactor is used to synthesize and/or screen multiple compounds or materials at the same time. Preferably, open-ended reactor vessels in the parallel reactor allow the pressure therein to remain substantially constant. An injection system delivers a specific mixture of gas to each reactor vessel. Preferably, the gas mixtures are delivered at substantially the same flow rate for some or all reactor vessels.

### CROSS REFERENCE TO RELATED APPLICATIONS

This application claims priority to prior U.S. Provisional Patent Application Serial No. 60/296,357, filed Jun. 6, 2001 which is incorporated by reference herein in its entirety.

### FEDERALLY SPONSORED RESEARCH

Not applicable.

### REFERENCE TO MICROFICHE APPENDIX

Not applicable.

### TECHNICAL FIELD OF THE INVENTION

The invention relates to a combinatorial method and apparatus for making, screening, and characterizing materials wherein process conditions are controlled and monitored. More particularly, the invention relates to a parallel reactor system and a method of using the system.

### BACKGROUND OF THE INVENTION

Chemical synthesis has historically been a slow and arduous process. With the advent of combinatorial methods, however, scientists can now create large libraries of compounds and materials at a much faster pace. Combinatorial methods refer to the techniques for creating a collection of chemically diverse compounds or materials using a relatively small set of precursors and for rapidly testing or screening the collection of compounds or materials for desirable performance characteristics and properties. Such techniques permit researchers to systematically explore the influence of structural variations in candidate compounds or materials by significantly accelerating the rates at which the candidates are created and evaluated. As compared to traditional methods, combinatorial methods can substantially reduce the cost of preparing and screening each candidate.

One impact of combinatorial methods can be seen, for example, in pharmaceutical research where the process of drug discovery has been greatly improved. (See, e.g., 29 Acc. Chem. Res. 1-170 (1996); 97 Chem. Rev. 349-509 (1977); S. Borman, Chem. Eng. News 57-64 (Feb. 12, 1996); N. Terret, 1 Drug Discovery Today 402 (1996)). In general, drug discovery can be viewed as a two-step process: (a) acquiring candidate compounds through laboratory synthesis or natural product collection; and (b) subsequent evaluation or screening for efficacy. In the second step, pharmaceutical researchers have long used high-throughput screening (HTS) protocols to rapidly evaluate the therapeutic value of natural products and compounds synthesized and cataloged over many years. The chemical synthesis step, on the other hand, has historically been a slow and arduous process compared to HTS protocols. With combinatorial methods, however, researchers can now synthesize large libraries of organic molecules at a pace that is more on par with HTS protocols.

Although combinatorial methods have also been successfully applied to drug research and discovery, they have not been widely used to study the influence of temperature, pressure, and other process conditions upon chemical reactions. For example, reaction conditions are important in synthetic chemistry and formulation chemistry. Investigation of the impact of reaction variables by traditional methods is time-consuming. Therefore, it is desirable to devise a method and apparatus for carrying out these reactions in a combinatorial fashion. Since numerous industrial processes are conducted in a constant pressure reactor, there is a need for a constant-pressure parallel reactor and a method of making and using the reactor.

### SUMMARY OF THE INVENTION

The present invention is directed to a parallel reactor system and method therefor. The parallel reactor is used to synthesize and/or screen multiple compounds or materials at the same time. Preferably, open-ended reactor vessels in the parallel reactor allow the pressure therein to remain substantially constant. An injection system delivers a specific mixture of gas to each reactor vessel. Preferably, the gas mixtures are delivered at substantially the same flow rate for some or all reactor vessels.

In general, in one aspect, the invention is directed to a reactor system for conducting a plurality of reactions simultaneously. The reactor system comprises a plurality of reactor vessels, each reactor vessel capable of maintaining a substantially constant pressure therein during a reaction and having a transfer line connected thereto. The reactor system further comprises a plurality of selector valves and a plurality of syringe pumps. Each selector valve is connected to a respective reactor vessel via the transfer line, and each syringe pump is adapted to contain a reagent therein and connected to a respective reactor vessel via a respective selector valve. A drive system is attached to the syringe pumps and operable to pump the syringe pumps. A control unit is connected to and configured to control the drive system and the selector valves so as to cause the syringe pumps to deliver the reagent to each reactor vessel at the same or substantially the same flow rate.

In general, in another aspect, the invention is directed to a reactor system for conducting a plurality of reactions in parallel. The reactor system comprises a plurality of reactor vessels adapted to hold a plurality of reaction components, the reactor vessels capable of maintaining a substantially constant pressure therein during a reaction. The reactor system further comprises a reactor unit capable of holding the plurality of reactor vessels, and an injection unit connected to the plurality of reactor vessels. A control unit is connected to and capable of causing the injection unit to deliver a reagent to each reactor vessel at the same or substantially the same flow rate.

In general, in another aspect, the invention is directed to a parallel reactor for use in a system adapted to carry out a plurality of reactions simultaneously. The parallel reactor comprises a plurality of reactor vessels for containing a plurality of reaction components, means for holding the plurality of reactor vessels, means for injecting a reagent into each one of the plurality of reactor vessels, and means for controlling the injecting means so that the reagents are injected into each reactor vessel in parallel and at the same or substantially the same flow rate.

In general, in another aspect, the invention is directed to a method of conducting a plurality of reactions in parallel. The method comprises placing a plurality of reaction components to be reacted in a plurality of reaction vessels arranged in parallel, injecting a reagent into the plurality of reaction vessels at the same or substantially the same flow rate, and maintaining a substantially constant pressure in at least one of the reactor vessels.

In general, in another aspect, the invention is directed to a method of preparing reagent mixtures in parallel. The method comprises simultaneously expanding a plurality of syringes to a first volume, filling the first volume of each syringe with a first reagent, simultaneously expanding the plurality of syringes to a second volume, and filling the second volume of each syringe with a desired reagent.

In general, in another aspect, the invention is directed to a parallel reactor for use in a system adapted to carry out a plurality of reactions simultaneously. The parallel reactor comprises a plurality of reactor vessels, each reactor vessel capable of maintaining a substantially constant pressure therein during a reaction and having a transfer line connected thereto. The parallel reactor further comprises a selector valve connected to each reactor vessel via a respective transfer line, and a delivery line and removal line connected to each selector valve. Valve actuators in each selector valve, the valve actuators are controllable to selectively connect the transfer line to either the delivery line or the removal line.

In general, in another aspect, the invention is directed to an injection system for a plurality of reactor vessels. The injection system comprises a plurality of syringe pumps, each syringe pump adapted to hold a reagent therein, and a drive system operatively attached to the plurality of syringe pumps. A supply valve is attached to each syringe pump and controllable to open the syringe pump to one of a plurality of reagent lines, and a control unit is connected to and configured to control the drive system to pump the syringe pumps to deliver the reagents therein to the reactor vessels at the same or substantially the same flow rate.

### BRIEF DESCRIPTION OF THE DRAWINGS

A more complete understanding of the method and apparatus of the present invention may be had by reference to the detailed description in conjunction with the following drawings.

FIG. 1 illustrates a system for the synthesis and screening of heterogeneous catalysts according to some embodiments of the invention.

FIGS. 2A-2C illustrate cross-sectional views of a reactor vessel according to some embodiments of the invention.

FIG. 3 illustrates a cross-sectional view of a parallel synthesis unit according to some embodiments of the invention.

FIG. 4 illustrates a cross-sectional view of a parallel reactor system according to some embodiments of the invention.

FIG. 5 illustrates a cross-sectional view of a selector valve unit according to some embodiments of the invention.

FIG. 6 illustrates a cross-sectional view of an injection system used in some embodiments of the invention.

FIG. 7 illustrates a cross-sectional view of a syringe pump assembly used in some embodiments of the invention.

FIG. 8 illustrates a functional block diagram of a control system of the injection system used in some embodiments of the invention.

FIG. 9 is a flow diagram illustrating a method of preparing gas mixtures according to some embodiments of the invention.

FIG. 10 is a flow diagram illustrating a method of using the parallel reactor system according to some embodiments of the invention.

### DESCRIPTION OF EMBODIMENTS OF THE INVENTION

Embodiments of the invention provide a parallel reactor system and method for using the system. The parallel reactor system may be a constant volume or constant pressure system. Preferably, the system is a constant pressure system. The parallel reactor system may be used to screen multiple compounds or materials at the same time. Preferably, the reactor system includes at least one of: (1) a plurality of reactor vessels; (2) a plurality of selector valves; (3) a plurality of syringe pumps; (4) a drive system attached to the syringe pumps; (5) and a control unit connected to the drive system and the selector valves. Preferably, each reactor vessel has a transfer line connected thereto, and each selector valve is connected to a respective reactor vessel via the transfer line. Each syringe pump preferably contains a reagent and is selectively connected to a respective reactor vessel via a respective selector valve. Preferably, the reactor vessels are adapted to allow the pressure therein to remain at an approximately constant value.

As used herein, the terms “parallel” or “in parallel” refer to events that take place or occur at the same time or substantially the same time; i.e., simultaneously or substantially simultaneously.

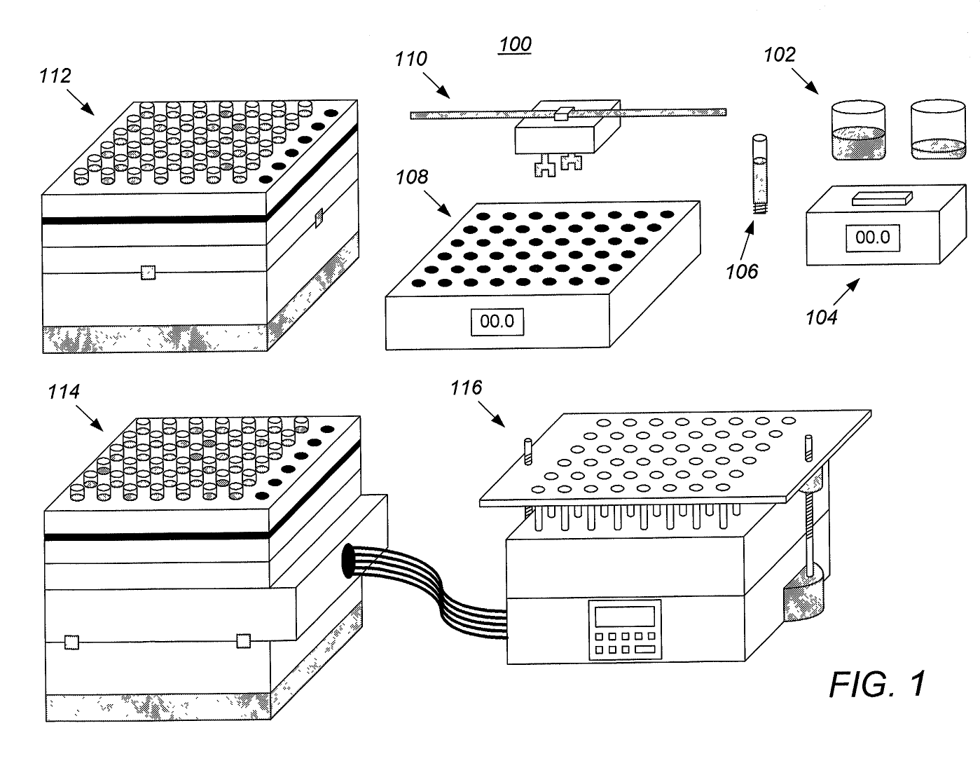

In some embodiments, the invention may be used to synthesize and/or screen heterogeneous or homogeneous catalysts in the liquid phase, with or without a gas phase. FIG. 1 generally illustrates a system 100 according to these embodiments. Starting materials 102 for synthesizing the catalysts are measured using a balance 104 and then placed in a plurality of reactor vessels, one of which is shown generally at 106. In some embodiments, a weighing station 108 may be use to securely hold the reactor vessels 106, while a computer-controlled automated liquid handling system 110 with a robotic arm may be used to pick up and transfer each reactor vessel to and from the balance 104 to be weighed. U.S. Pat. Nos. 6,045,671 and 6,175,409 disclose a robotic handling system which may be used in these embodiments of the invention. The disclosures of the two patents are incorporated by reference in their entirety herein. In other embodiments, the handling of the starting material 102 may be done manually. The weighing station 108 may also be used to measure the weight of all the reactor vessels 106.

The reactor vessels 106 containing the starting materials 102 may thereafter be removed from the weighing station 108 and placed in a solid phase synthesis unit 112 in order to synthesize the catalysts. U.S. Pat. No. 5,792,430 discloses an exemplary solid phase synthesis unit which may be used in these embodiments of the invention. The disclosure of this patent is incorporated by reference in its entirety herein. In some embodiments, the solid phase synthesis unit 112 can accommodate up to 8 rows of 6 reactor vessels per row for a total of 48 reactor vessels. This arrangement advantageously allows up to 48 catalysts to be synthesized in parallel, thereby substantially reducing the amount of time required for synthesis and/or screening relative to a sequential process.

After the catalysts have been synthesized and/or dried, annealed, or otherwise treated and processed offline, the reactor vessels 106 may be removed from the solid phase synthesis unit 112 and placed in a parallel reactor unit 114 in order to screen and characterize the properties thereof. The parallel reactor unit 114, like the solid phase synthesis unit 112, can accommodate 8 rows of 6 reactor vessels per row for a total of 48 reactor vessels. Thus, up to 48 heterogeneous or homogeneous catalysts may be screened and characterized in parallel, thereby significantly reducing the amount of time required for screening and characterizing relative to a sequential process.

It should be understood that any number of reactor vessels may be used in parallel, for example, 12, 24, 56, 64, 72, 81, 100, 120, and so on. Sometimes, not all reactor vessels are used in conducting a reaction.

An injection system 116 optionally may be used to sparge or otherwise introduce a reagent, preferably a gas or mixture of gases, into the reactor vessels. A different gas or mixture of gases may be sparged into each reactor vessel, or the same gas or mixture of gases may be sparged into several reactor vessels. In some embodiments, the injection system 116 is capable of delivering the gas or mixture of gases to up to 48 reactor vessels in parallel or simultaneously. Thus, up to 48 different oxidation or other reaction processes may be carried out at the same time in the 48 reactor vessels, thereby greatly reducing the amount of time required to conduct 48 reactions in a sequential process. In some embodiments, the injection system 116 is capable of delivering the gas mixtures to the reactor vessels 106 at the same or substantially the same gas flow rate, thereby ensuring a consistent flow of gas to all the reactor vessels 106.

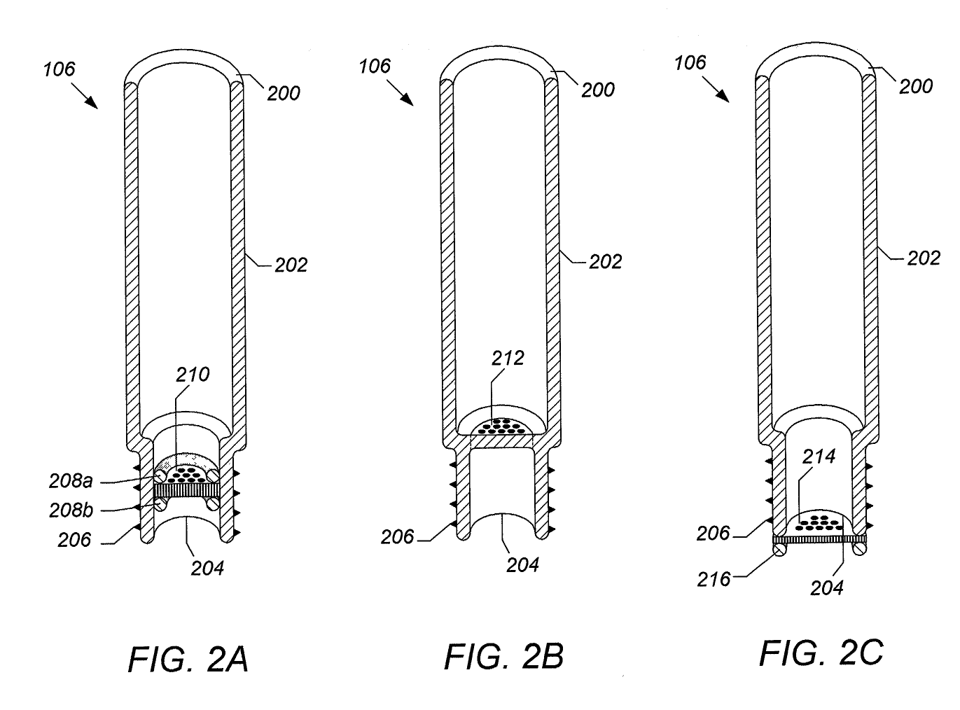

The reactor vessels 106, in general, may be any container of a suitable shape and material for carrying out a reaction such as synthesizing the heterogeneous or homogeneous catalysts and performing heterogeneously or homogeneously catalyzed reactions. In some embodiments, the reactor vessels 106 may be threaded glass cylinders or vials as shown in FIGS. 2A-2C. Referring to FIG. 2A, such a reactor vessel 106 preferably has a mouth portion 200 which is open to the surrounding environment, a body portion 202 connected thereto, and an open-bottom neck portion 204 connected to the body portion 202. The mouth portion 200, body portion 202, and neck portion 204 together define a longitudinal flow path through the reactor vessel 106.

The mouth portion 200, by virtue of being open to the surrounding environment, allows the pressure within the reactor vessel 106 to remain substantially the same as that of the surrounding environment. The mouth portion 200 also facilitates easy placement and removal of reaction components into and out of the body portion 202. In most cases, the reactor pressure is the atmospheric pressure, i.e., approximately 1 atm. In other embodiments, however the reactor pressure may be higher or lower than 1 atm, such as 0.5 atm, 1.5 atm, 2 atm, 10 atm, and so on. In that case, the reactor vessel may need to be modified to accommodate the higher or lower reactor pressure.

The body portion 202 holds the heterogeneous or homogeneous catalysts within the reactor vessel 106. In some embodiments, the inner surface of the body portion 202 may be treated with dichlorodimethyl silane to render the surface hydrophobic. This is done to prevent the catalysts from adhering to the inner surface of the body portion 202.

The neck portion 204 has threads 206 on the outer surface for providing a threaded connection between the reactor vessel 106 and the solid phase synthesis unit 112 as well as the parallel reactor unit 114.

Mounted within the neck portion 204 are a pair of elastomeric O-rings 208a and 208b that support a removable filter 210 therebetween. The two O-rings 208a and 208b are themselves removable and are held in place, for example, by friction. Such an arrangement provides a fluid-tight seal between the inner surface of the reactor vessel 106 and the filter 210, and prevents the filter 210 from turning or otherwise working loose.

The filter 210 serves to retain the heterogeneous catalysts and/or a liquid within the body portion 202 of the reactor vessel 106 while allowing a gas to freely pass therethrough. In some embodiments, the filter 210 may be made of a fritted glass, porous plastic (e.g., polyethylene, polypropylene, Teflon™, hydrophilic polyethylene, PEEK, PEEK alloyed with Teflon™, and the like), stainless steel, or filter paper. In general, however, any material having a porosity that can provide the described function may be used to form the filter 210.

FIG. 2B illustrates an embodiment of the invention wherein a filter 212 is formed as an integral part of the reactor vessel 106 instead of as a separate removable component. Such an arrangement may not only be more convenient, but may also ensure there are no gaps or space between the filter 212 and the inner surface of the reactor vessel 106.

FIG. 2C illustrates an embodiment of the invention wherein a filter 214 is disposed under the open-bottom neck portion 204 of the reactor vessel 106. An elastomeric O-ring 216 is placed underneath the filter 214 as shown such that the filter 214 and the reactor vessel 106 are resting on top of the elastomeric O-ring 216. As such, the filter 214 is securely held in place by the reactor vessel 106 and the elastomeric O-ring 216. The filter 214 may be made of any of the filter materials mentioned above. If filter paper is used for the filter 214, the filter paper is preferably Whatman No. 1, available from Whatman plc, Whatman House, St. Leonard's Road, 20/20 Maidstone, Kent, ME16 OLS, U.K.

Note in FIGS. 2A-2C that the neck portion 204 is shown as narrower than the body portion 202 only to emphasize the distinction therebetween, and that the invention is not to be limited thereto. In general, the specific diameters, lengths, and/or ratios thereof for the mouth portion 200, body portion 202, and neck portion 204 of the reactor vessel 106 may be any number and can be chosen as needed for a particular application. Preferably, the aspect ratio, i.e., the height over the diameter, of the body portion 202 should be relatively large. For example, it should be at least 1, preferably 2, 3, 4, or 5.

In some embodiments, the reactor vessel 106 may simply be a straight glass or metal tube without threads. In that case, a gas tight seal may be provided by a compression fitting (not expressly shown) that fits on the outside of the tube. The filter may then be a disc that is pressed into the compression fitting against the bottom of the tube.

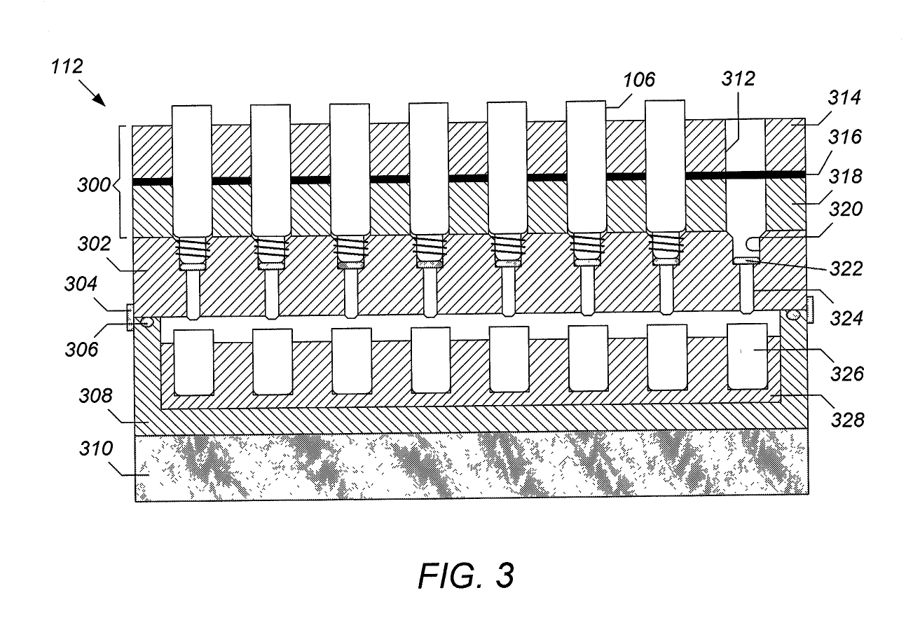

Once preparation of the starting materials 102 have been completed, the reactor vessels 106 containing the starting materials are placed in the solid phase synthesis unit 112 in order to synthesize the heterogeneous or homogeneous catalysts. FIG. 3 illustrates a cross-sectional view of the solid phase synthesis unit 112 according to some embodiments of the invention. As can be seen, the solid phase synthesis unit 112 has a reactor block 300 for housing the reactor vessels 106 and a substrate 302 attached thereto for securely mounting the reactor vessels 106 therein. Locking clips or clamps 304 and an elastomeric member 306 clamp the substrate 302 to a plenum 308 and serve to create a gas tight seal therebetween. Such a gas tight seal allows the plenum 308 to be subsequently evacuated as needed for vacuum filtration of the reactor vessels 106. A robotic shaker 310 such as an orbital shaker is attached to the plenum 308 and is operable to shake the reactor vessels 106 to thereby agitate the contents of the reactor vessels 106. In some embodiments, the robotic shaker 310 may be configured to return to a “home” or reset position to facilitate addition of reagents to the reactor vessels 106 by the automated liquid handler 110.

The reactor block 300 of the solid phase synthesis unit 112 includes a plurality of reactor wells, defined by the well walls 312, for receiving the reactor vessels 106. A cooling zone 314, an insulation layer 316, and a heating zone 318 surround each one of the reactor vessels 106 in the reactor block 300 and may be used to heat and cool the heterogeneous catalysts in the reactor vessels 106 as needed for synthesis thereof.

The substrate 302 of the solid phase synthesis unit 112 includes a plurality of threaded bores, defined by the bore walls 320, into which the reactor vessels 106 may be screwed in order to ensure a secure mount therefor. A person having ordinary skill in the art will recognize that other mounting means besides a threaded connection may be used to mount the reactor vessels 106 to the substrate 302. In some embodiments, an elastomeric O-ring 322 may be disposed at the bottom of each one of the threaded bores to form a gas tight seal between the substrate 302 and the reactor vessels 106. Where the reactor vessels 106 are of the type shown in FIG. 2C, the elastomeric O-rings 322 may take the place of the elastomeric O-rings 216.

At any time during or after the synthesis reaction, a vacuum may be created in the space between the plenum 308 and the substrate 302 for vacuum filtration of the reactor vessels 106. Liquids that may be present in the reactor vessels 106 are then suctioned by the force of the vacuum through drains 324 protruding through the bottom of the substrate 302 and collected in a plurality of collection vials 326. The collection vials 326 are held in a removable rack 328 that may be removed by unlocking the locking clamps 304 and lifting off the substrate 302 and the reactor block 300.

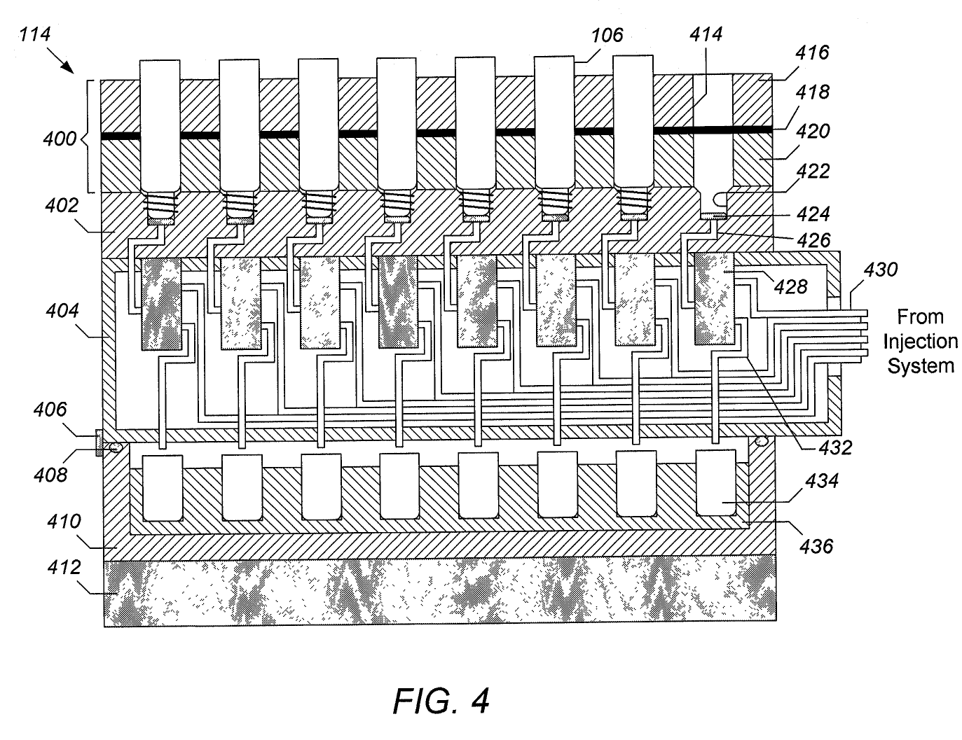

After the heterogeneous or homogeneous catalysts have been synthesized, the reactor vessels 106 are removed from the solid phase synthesis unit 112 and transferred to the parallel reactor unit 114 for screening and characterizing of the heterogeneous catalysts. FIG. 4 illustrates a cross-sectional view of the parallel reactor unit 114 according to some embodiments of the invention. Like the solid phase synthesis unit 112, the parallel reactor unit 114 also has a reactor block 400 attached to a substrate 402 for housing the reactor vessels 106. In addition, the parallel reactor unit 114 also has a selector valve housing 404 that houses a plurality of valves which facilitate selection between delivery of a gas mixture to, or removal of unwanted fluids from, the reactor vessels 106. Locking clips or clamps 406 and an elastomeric member 408 clamp the selector valve housing 404 to a plenum 410 to create a gas tight seal therebetween. A robotic shaker 412 such as an orbital shaker having the “home” or reset feature is attached to the plenum 410 and may be used to agitate the contents of the reactor vessels 106.

The reactor block 400 of the parallel reactor unit 114 includes a plurality of reactor wells, defined by the well walls 414, similar to the reactor wells in the solid phase synthesis unit 112 (see FIG. 3) for receiving the reactor vessels 106. Likewise, a cooling zone 416, an insulation layer 418, and a heating zone 420 may be operated to heat and cool the catalysts in the reactor vessels 106 as needed.

The substrate 402 of the parallel reactor unit 114 includes a plurality of threaded bores, defined by the bore walls 422, into which the reactor vessels 106 may be screwed (similar to the ones in the solid phase synthesis unit 112). An elastomeric O-ring 424 is also available, in some embodiments, in the threaded bores for forming a gas tight seal between the substrate 402 and the reactor vessels 106. Where the reactor vessels 106 are of the type shown in FIG. 2C, the elastomeric O-rings 424 may take the place of the elastomeric O-rings 216.

A plurality of transfer lines 426, one for each reactor vessel, connect the reactor vessels 106 to respective ones of a plurality of selector valves 428 mounted in the selector valve housing 404. Each selector valve 428 connects the respective reactor vessel 106 either to a delivery line 430 extending from the injection system 116 through an opening in the selector valve housing, or to a removal line 432 extending through the bottom of the selector valve housing into the plenum 410. Because each transfer line 426 may be connected to a separate delivery line 430 (via the selector valve 428), each reactor vessel 106 consequently may receive a separate mixture of gas from the injection system 116.

After oxidation or other reaction in the presence of a catalyst has been completed, a vacuum may be created in the space between the plenum 410 and the substrate 404 for vacuum filtration of the reactor vessels 106. Any liquids that may be present in the reactor vessels 106 at this time are suctioned through the removal lines 432 and collected in the respective collection vials 436. As in the solid phase synthesis unit, the collection vials 436 are held in a removable rack 438 that may be taken out after unlocking the locking clamps 406 and lifting off the substrate 402 and the reactor block 400.

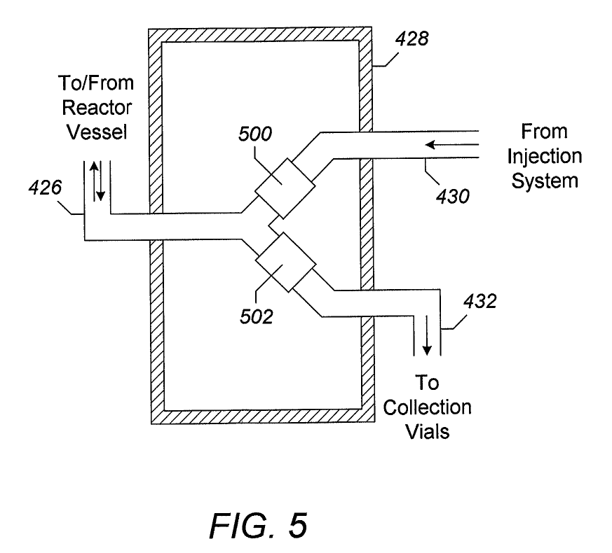

FIG. 5 illustrates a close-up cross-sectional view of the selector valve 428 according to some embodiments of the invention. As can be seen, the transfer line 426 to/from the reactor vessel 106 may be connected to either the delivery line 430 from the injection system 116, or the removal line 432 that drains into the collection vial 436. Selection between the delivery line 430 and the removal line 432 is controlled by valve actuators 500 and 502 which open and close the delivery line 430 and removal line 432, respectively. In general, any type of mechanical valve may be used for the selector valve 428, but preferably the valve actuators 500 and 502 are solenoid-controlled valve actuators. Such solenoid valves are commercially available from, for example, E. Clark Associates, 55 Green Street, Clinton, Mass. 01510.

In operation, when a gas mixture is to be delivered to the reactor vessel 106, the valve actuators 500 and 502 are controlled to open the path to the delivery line 430 and close the path to the removal line 432, respectively, thereby connecting the transfer line 426 to the delivery line 430. When delivery of the gas mixture is completed, the valve actuators 500 and 502 are controlled to close the path to the delivery line 430 and open the path to the removal line 432, respectively, thereby connecting the transfer line 426 to the removal line 432.

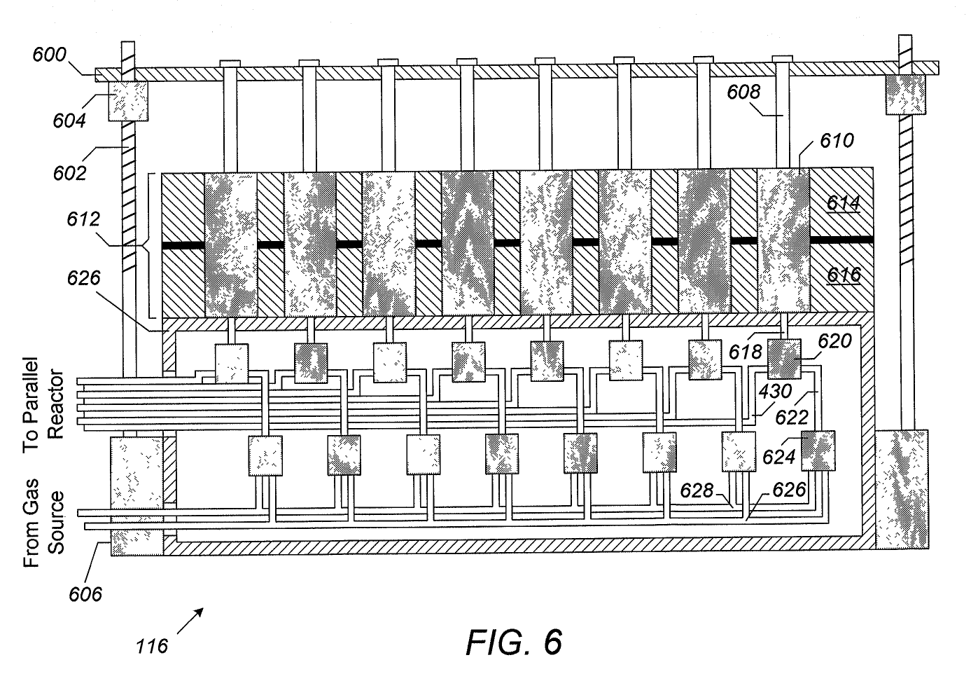

Delivery of the gas or mixture of gases is accomplished by the use of the injection system 116, a cross-sectional view of which is shown in FIG. 6, according to some embodiments of the invention. As can be seen, the injection system 116 includes a syringe plate 600, the opposing sides of which are mounted to a threaded shaft 602 and supported by a ball 604 that is threadedly engaged with the threaded shaft 602. A stepper motor 606 is attached to the threaded shaft 602 and may be configured to rotate the threaded shaft 602 in predefined increments or steps. By rotating the threaded shaft 602, the ball 604 may be moved up and/or down to multiple positions along the threaded shaft 602 in precisely controlled increments. Hence, the syringe plate 600 may also be moved up or down to multiple positions along the threaded shaft 602. Such an arrangement is commonly referred to as a “ball-and-screw” drive.

It should be noted that while the ball-and-screw drive is an effective way to deliver the gas mixtures to the reactor vessels, the invention is not to be limited thereto. In general, any drive system that is capable of performing the described function may be used. For example, instead of a ball-and-screw drive, a hydraulic drive may be used in some embodiments, or a spring based drive system, or a latch and gear based system such as the one disclosed in published PCT Application WO 00/32308 which is incorporated herein by reference.

The syringe plate 600 is in turn attached to a plurality of plungers 608 that are slidingly engaged with a plurality of syringes 610 which hold the gas mixtures to be delivered to the reactor vessels 106. Thus, when the syringe plate 600 is raised and/or lowered to the various positions by the operation of the ball-and-screw drive, the plurality of plungers 608 are also raised and/or lowered accordingly. In some embodiments, the plungers 608 are all approximately of the same length, and the syringes 610 are all approximately of the same width and height relative to one another. Such an arrangement advantageously allows the gas mixtures contained in the syringes 610 to be delivered to each reactor vessel 106 under the same or substantially the same gas flow rate.

A syringe block 612 houses the plurality of the syringes 610 and includes a cooling zone 614 and a heating zone 616 for cooling and heating the gas mixtures as needed. The delivery lines 430, as described earlier, connect a respective one of the plurality of syringes 610 to a respective one of the reactor vessels 106. The syringes 610 are further connected via a plurality of pass lines 618 to a respective one of a plurality of control valves 620. Each of the control valves 620 is in turn connected to one of the delivery lines 430 and a supply line 622. The control valves 620 control the flow of gases out of and into the syringe 610 via the delivery lines 430 and the supply lines 622, respectively. Each supply line 622 is connected to a respective one of a plurality of supply valves 624. The supply valves 624 open and close a plurality of gas lines 626 and 628 to provide gas into the syringe 610. A valve block 626 houses the plurality of control valves 620 and supply valves 624, and has openings formed therein for accommodating the routing of the delivery lines 430 and gas lines 626 and 628.

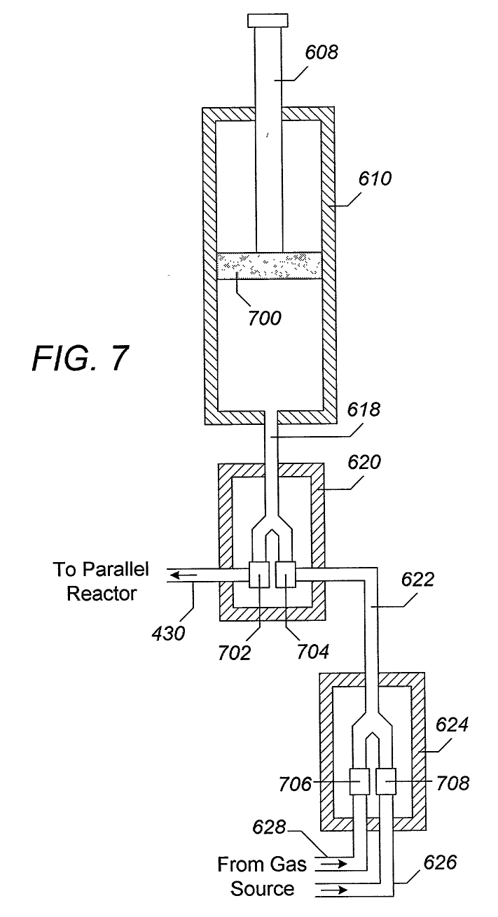

FIG. 7 illustrates a close-up cross-sectional view of the syringe pump assembly according to some embodiments of the invention. As can be seen, a plunger head 700 is attached to one end of the plunger 608 within the syringe 610 and preferably forms a gas tight and liquid tight seal with the inner surface of the syringe 610. The plunger head 700 may be raised and/or lowered to multiple positions as needed in precise increments by the raising and/or lowering of the plunger 608 (the movement of which is controlled by the syringe plate 600 via operation of the ball-and-screw drive).

A plurality of control valve actuators 702 and 704 control the selection of whether the delivery line 430 or the supply line 622 is open. In general, when either one of the delivery line 430 or supply line 622 is open, the other one is closed. A plurality of supply valve actuators 706 and 708 control the selection of the particular gas lines 626 and 628 that supply gas into the syringe 610. In general, any type of valves may be used, but preferably the control valve actuators 702 and 704 and the supply valve actuators 706 and 708 are solenoid-controlled valve actuators similar to the valve actuators 500 and 502 discussed previously.

In operation, the plunger head 700 is raised to a preselected position to prepare the gas mixture to be delivered to the reactor vessel 106. The raising of the plunger head 700 creates a slight vacuum pressure in the syringe 610 to draw the gas or mixture of gases into the syringe 610. The delivery line 430 is closed and the supply line 622 is opened during this time via a respective one of the control valves 620. One or possibly several of the supply valve actuators 706 and 708 in the supply valve 624 are thereafter opened, and the desired gas or gases flows through the pass line 618 into the syringe 610. The desired gas or gases should be allowed to flow for a sufficient time period to fill the syringe 610 up to the plunger head 700. The plunger head 700 may then be pulled back to another predetermined position and additional/different gases may flow into the syringe 610 by opening one or more supply valve actuators 706 and 708. This process may be repeated until the desired amount and/or mixture of gases has been achieved in the syringe 610.

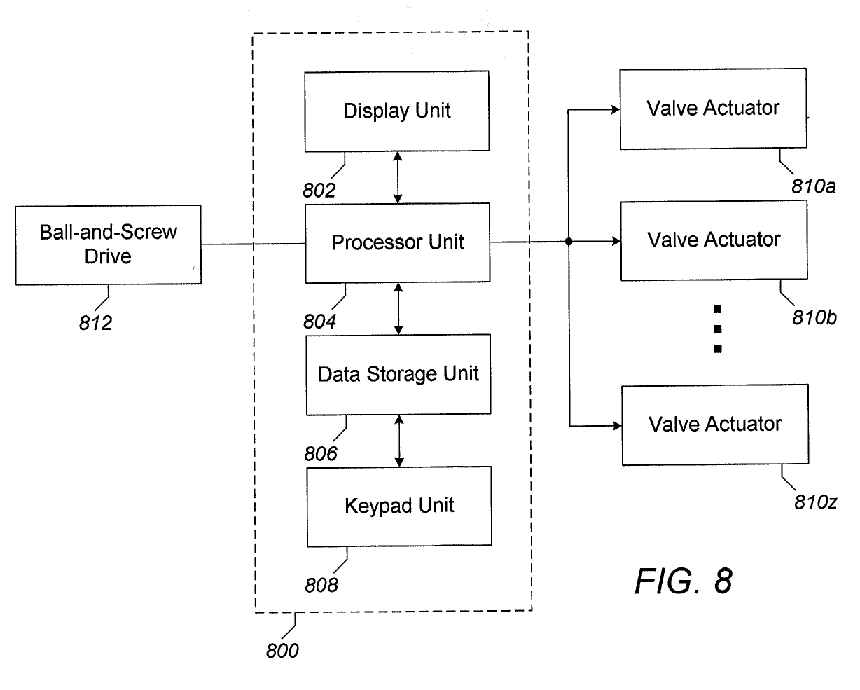

Control of the plurality of selector valves 428, control valves 620, supply valves 624, and the stepper motor 606 may be effected, for example, by a single centralized control unit. FIG. 8 illustrates a functional block diagram of a control unit 800 according to some embodiments of the invention. As can be seen, the control unit 800 has a display unit 802, a processor unit 804, a data storage unit 806, and a keypad unit 808, all interconnected as shown. The processor unit 804 is further connected to and controls a plurality of valve actuators 810a-810z, each of which may be operated to close or open a respective flow path. The processor unit 804 is also connected to and controls a transfer drive 812 for driving the syringe pumps of the injection unit 116.

The display unit 802 of the control unit 800, which may be any suitable display media such as a liquid crystal display, may be used to visually display any data or information that may be outputted from the processor unit 804.

The processor unit 804 also dictates the operation of all the valve actuators 810a-810z as well as of the transfer drive 812. In some embodiments, the processor unit 804 may include any suitable processing unit such as a microprocessor, microcontroller, ASIC, DSP, or the like.

Data and software programs used by the processor unit 804 are stored in the data storage unit 806, which provides both long-term and short-term data storage therefor and may include any suitable data storage media such as a hard disk drive, CD-ROM drive, random access memory, read only memory, or some combination thereof.

Manual data entry and operation of the control unit 800 is facilitated by the keypad unit 806 which allows manual entry of commands and data from a user to the control unit 800 and may be any standard keypad or keyboard.

The valve actuators 810a-810z open and close the respective flow path connected thereto upon receiving an appropriate command from the processor unit 804, and may be any suitable valve actuators such as a solenoid-controlled actuator.

Finally, the transfer drive 812 may be any suitable drive mechanism such as the ball-and-screw drive described above for raising and/or lowering of the syringe plate 600.

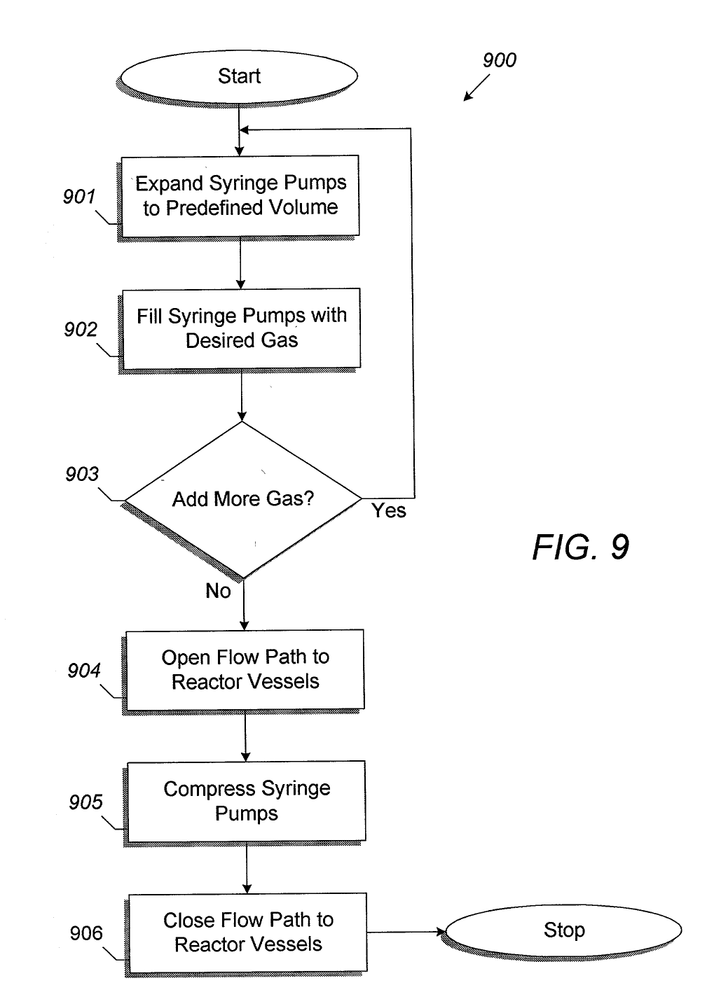

Operation of the control unit 800 to control the valve actuators 810a-810z and the transfer drive 812 is described with respect to FIG. 9. As can be seen, a method 900, according to some embodiments of the invention, begins by expanding the syringe pump to a predefined volume at step 901 by, for example, operating the transfer drive (e.g., ball-and-screw drive) to raise the syringe plate to a desired position. At step 902, the syringe pump is filled with a desired gas or mixture of gases by, for example, controlling the appropriate valve actuators to open the desired gas lines. At step 903, a determination is made as to whether additional gas or mixture of gases are to be added to the syringe pumps. If the answer is yes, then the expanding and filling steps 901 and 902 are repeated. If the answer is no, a flow path is opened between the syringe pumps and the reactor vessels at step 904 by, for example, controlling the appropriate valve actuators to open the delivery lines (and close the removal lines). The syringe pumps are thereafter compressed to deliver the gas or mixture of gases to the reactor vessels at step 905 by, for example, controlling the transfer drive to lower the syringe plate. Finally, the flow path is closed between the syringe pumps and the reactor vessels at step 906 (via the appropriate valve actuators) and the method may be repeated or ended.

Note that the above process allows any number of different gas mixtures to be created in parallel. For example, assume the syringes have a volume of 100 ml, and a gas mixture containing 50% oxygen and 50% nitrogen is to be prepared in one syringe, while another gas mixture containing 25% oxygen and 75% nitrogen is to be prepared in a second syringe. Both mixtures of gas may be prepared by raising the plunger head in each syringe at the same time (via the syringe plate) to three different positions: 25 ml, 50 ml, and 100 ml. The 25 ml position allows both syringes to be filled with 25 ml of oxygen. The oxygen line is then kept open to the first syringe and closed off to the second syringe, and the nitrogen line is opened to the second syringe. The plunger heads are then moved to the 50 ml position, which allows the first syringe to be filled an additional 25 ml of oxygen while the second syringe is filled with 25 ml of nitrogen. The oxygen line is then closed to the first syringe and the nitrogen line is opened thereto. The plunger head is then raised to the 100 ml position and the remainder of both syringes is filled with nitrogen (50 ml). Through this incremental process, the two syringes now contain their intended gas mixtures.

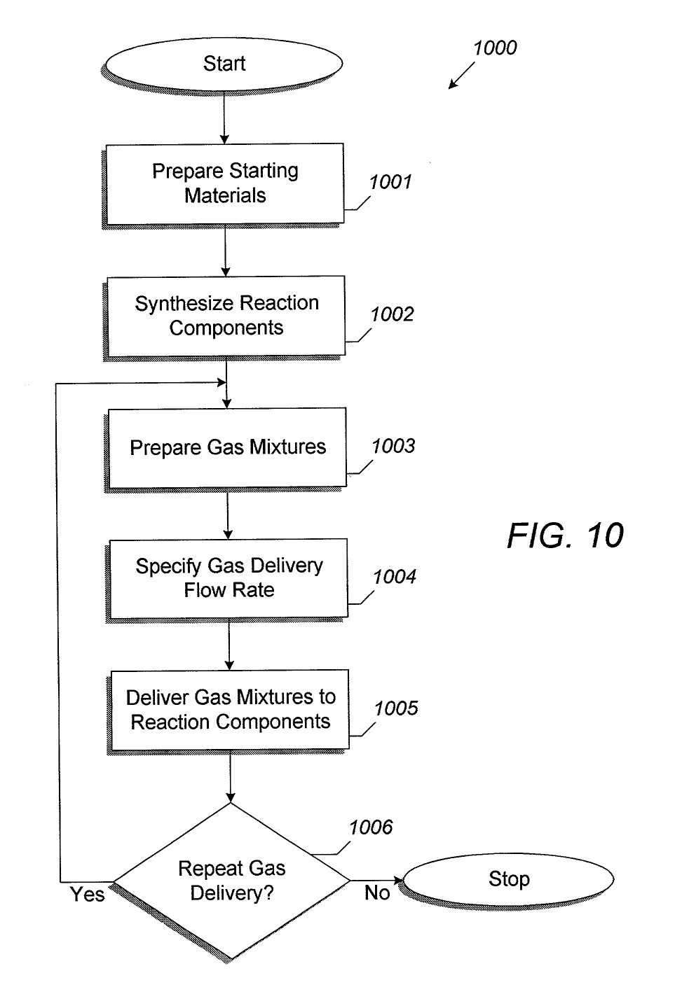

FIG. 10 illustrates, in a general sense, a method 1000 of using a constant pressure parallel reactor system according to some embodiments of the invention. At step 1001, the starting material for the heterogeneous catalysts or other reaction components are prepared by, for example, measuring and placing them in the reactor vessels. The reaction components are thereafter synthesized and/or otherwise treated at step 1002, for example, in a solid phase synthesis unit. Gas mixtures are prepared at step 1003, preferably each reactor vessel receiving a different mixture of gases, or several reactor vessels receiving the same mixture of gases. At step 1004, the gas flow rate at which the gas mixtures will be delivered is specified, and the gas mixtures are thereafter delivered to the reactor vessels at step 1005. At step 1006, a determination is made as to whether the gas delivery step should be repeated. If the answer is no, then the method is ended. If the answer is yes, then the method returns to the gas preparation step 1003 for additional preparation of the gas mixtures as needed.

The same gas flow rate may be specified for each gas delivery step, or a different flow rate may be used for some gas delivery steps. Also, a varying (increasing/decreasing) flow rate may be used within a single gas delivery step instead of a constant flow rate.

It should be noted that possible embodiments of the invention are not limited only to those described herein. For example, the continuous feed parallel reactor system and various components thereof disclosed in PCT Application WO 00/32308 may be used to practice method of the invention with some modifications. Similarly, the reactors disclosed in U.S. Pat. Nos. 5,288,468 and 6,149,882 may also be used to implement embodiments of the invention. All of the preceding references are incorporated by reference in their entirety herein.

If desired, an in situ detection mechanism may be added to various embodiments of the invention to further increase efficiency. U.S. Pat. Nos. 5,959,297, 6,034,775, 6,087,181, 6,151,123, 6,157,449, 6,175,409 and 6,182,499 disclose various detection mechanisms which may be used in embodiments of the invention with or without modifications. All of the preceding U.S. patents are incorporated herein by reference in their entirety.

Many different types of reactions can be studied in parallel using the apparatus and methods described herein, including carbonylation, hydroformylation, oxidation, reduction, hydroxycarbonylation, hydrocarbonylation, hydroesterification, hydrogenation, transfer hydrogenation, hydrosilylation, hydroboration, hydroamination, epoxidation, aziridination, reductive amination, C—H activation, insertion, C—H activation-insertion, C—H activation-substitution, C-halogen activation, C-halogen activation-substitution, C-halogen activation-insertion, cyclopropanation, alkene metathesis, alkyne metathesis and polymerization reactions of all sort, including alkene oligomerization, alkene polymerization, alkyne oligomerization, alkyne polymerization, co-polymerization, CO-alkene co-oligomerization, CO-alkene co-polymerization, CO-alkyne co-oligomerication, CO-alkyne co-polymerization, coordination polymerizations, cationic polymerizations and free radical polymerizations.

Most of the reactions may be carried out in semi-continuous or continuous processes, where one or more reagents is metered into the process reactor at a controlled rate. Other processes are conducted in a continuous manner, where reagents are metered into the process reactor at a controlled rate, while products are removed from the reactor. It is frequently important to screen candidate catalysts, materials, and processes under realistic process conditions. Many catalytic reactions proceed most favorably when one or more reagents is maintained at a low concentration during the course of the reaction. Semi-continuous and continuous processes allow such conditions to be established, if the rate of reagent is consumed in the reactor at a rate comparable or faster than the rate at which it is introduced. Semi-continuous and continuous processes also allow for efficient use of industrial reactor capacity, since the final concentration of products can be much higher than the instantaneous concentration of starting materials during the course of the reaction. Also, semi-continuous and continuous processes are readily controlled, because the rate of heat release is limited by the rate of reagent addition to the reactor. Semi-continuous and continuous processes can add the reagents more slowly than the rate of reaction, so that the instantaneous concentration of reagents is low throughout the process, but so that the concentration of product from the reactor is high. Reactions that benefit from this mode include cyclization reactions to form medium- and large-sized rings, reactions where one or more of the reagents is prone to unwanted self-reaction or polymerization, and catalytic processes where one or more reagents acts as an inhibitor to the catalyst. Furthermore, semi-continuous and continuous processes may allow for the production of more chemically uniform copolymers because the process can occur with a low concentration of monomer.

Emulsions polymerization processes produce polymer dispersions or colloids, typically of small polymer particles in water stabilized by surfactant. Such colloids are frequently unstable in the presence of organic solvents or molecules, such as monomers. Semi-continuous and continuous process can produce emulsions with the slow addition of monomer, because the monomer concentration is maintained very low during the process. Also, semi-continuous and continuous processes allow unstable, highly reactive reagents, such as thermal initiators, to be metered throughout the course of the process, so that useful concentrations of the reagent is maintained until the reaction is complete.

Any form of catalysts may be used in embodiments of the invention. They include, but are not limited to, homogeneous catalysts, heterogeneous catalysts, phase-transfer catalysts, and arrays of catalysts. It should be understood that embodiments of the invention may also be used to study those reactions which do not require a catalyst. In addition, embodiments of the invention may be carried out according to the methods described in U.S. Pat. Nos. 5,985,356, 6,004,617, 6,030,197, 6,149,882, and 6,187,164, which are incorporated in their entirety herein by reference.

As demonstrated above, embodiments of the invention provide a parallel reactor system and method therefor wherein mixtures of gas may be sparged into the reactor vessels. The parallel reactor system allows a plurality of heterogeneous reactions, including gas, liquid, and solid phases, to be conducted in a combinatorial manner. Moreover, specific mixtures of gas may be prepared and delivered in parallel to each of the reactor vessels. As such, the parallel reactor may significantly speed up research and development cycles. Additional advantages provided by the embodiments of the invention are apparent to those skilled in the art.

While a limited number of embodiments of the invention have been described, these embodiments are not intended to limit the scope of the invention as otherwise described and claimed herein. Variations and modifications from the described embodiments exist. For example, in some embodiments, instead of using open-ended reactor vessels wherein the pressure remains the same as the surrounding environment (e.g., 1 atmosphere), vent needles or other pressure control means may be used to maintain the pressure at a different value. In other embodiments, rather than injecting the gas mixtures through the bottom of the reactor vessels, a different injection point such as from the side or top of the reactor vessels may be used. In still other embodiments, instead of using syringes that are approximately all the same size to achieve a consistent flow rate relative to all syringes, different size syringes may be used to achieve different flow rates for each syringe. Moreover, unless otherwise specified, the steps of the methods described may be practiced in any order or sequence. Furthermore, some steps may be omitted, combined into a single step, or divided into several sub-steps. All numbers disclosed herein are approximate values regardless of whether that term was used in describing the numbers. Accordingly, the appended claims are intended to cover all such variations and modifications as falling within the scope of the invention.

What is claimed is:

1. A reactor system for conducting a plurality of reactions simultaneously, comprising:
a plurality of reactor vessels, each reactor vessel capable of maintaining a substantially constant pressure therein during a reaction and having a transfer line connected thereto;
a plurality of selector valves, each selector valve connected to a respective reactor vessel via the transfer line;
a plurality of syringe pumps, each syringe pump adapted to contain a reagent therein and selectively connected to a respective reactor vessel via a respective selector valve;
a drive system attached to the syringe pumps and operable to pump the syringe pumps; and
a control unit connected to and configured to control the drive system and the selector valves so as to cause the syringe pumps to deliver the reagent to each reactor vessel at the same or substantially the same flow rate.

2. The reactor system of claim 1, wherein each selector valve is controllable to close either a delivery line or a removal line to a respective one of the transfer lines.

3. The reactor system of claim 1, further comprising a heating zone and a cooling zone operable to heat and cool the reactor vessels, respectively.

4. The reactor system of claim 1, further comprising a substrate having threaded bores formed therein.

5. The reactor system of claim 4, further comprising an elastomeric ring disposed in each of the threaded bores between the substrate and the reactor vessels.

6. The reactor system of claim 1, further comprising a robotic shaker operable to shake the reactor vessels and configurable to return to a reset position.

7. The reactor system of claim 1, wherein each reactor vessel includes a mouth portion that is open to the surrounding environment.

8. The reactor system of claim 7, wherein each reactor vessel includes a neck portion having threads thereon.

9. The reactor system of claim 8, wherein the neck portion of each reactor vessel includes a gas permeable filter integrally formed therein.

10. The reactor system of claim 9, wherein the neck portion of each reactor vessel includes a removable gas permeable filter disposed therein.

11. The reactor system of claim 10, wherein the removable gas permeable filter is sandwiched between a pair of elastomeric O-rings.

12. The reactor system of claim 8, wherein the neck portion of each reactor vessel has a removable gas permeable filter and an elastomeric 0-ring disposed thereunder.

13. The reactor system of claim 1, wherein each selector valve includes a solenoid-controlled valve cover.

14. The reactor system of claim 1, wherein the drive system includes a ball-and-screw drive.

15. The reactor system of claim 1, wherein each syringe pump includes at least one valve controllable to open the syringe pump to one of a plurality of reagent lines.

16. The reactor system of claim 1, wherein each syringe pump contains a different reagent.

17. The reactor system of claim 1, wherein several syringe pumps contain the same reagent.

18. The reactor system of claim 1, wherein the drive system includes a syringe plate, and each syringe pump includes a slidingly engaged plunger attached to the syringe plate.

19. The reactor system of claim 1, wherein the control unit includes a processor unit and a data storage unit, the data storage unit storing instructions for instructing the processor unit to:
(a) expand the syringe pumps to a predefined volume;
(b) fill the syringe pumps with a desired reagent;
(c) open a flow path between the syringe pumps and the reactor vessels;
(d) compress the syringe pumps in parallel; and
(e) close the flow path between the syringe pumps and the reactor vessels.

20. The reactor system of claim 19, wherein instructions (a)-(b) are repeated one or more times before instructions (c)-(e) are executed.

21. The reactor system of claim 1, wherein the plurality of reactions include an oxidation reaction in the presence of a heterogeneous catalyst in the liquid phase.

22. A reactor system for conducting a plurality of reactions in parallel, comprising:
a plurality of reactor vessels adapted to hold a plurality of reaction components, the reactor vessels capable of maintaining a substantially constant pressure therein during a reaction;
a reactor unit capable of holding the plurality of reactor vessels;
an injection unit connected to the plurality of reactor vessels; and
a control unit connected to and capable of causing the injection unit to deliver a reagent to each reactor vessel at the same or substantially the same flow rate.

23. The reactor system of claim 22, wherein the reactor unit includes a reactor block capable of receiving the reactor vessels and heating and cooling the reactor vessels.

24. The reactor system of claim 22, wherein the reactor unit includes a substrate for securely mounting the reactor vessels therein.

25. The reactor system of claim 22, wherein the reactor unit includes a plurality of selector valves connecting the reactor vessels to the injection unit.

26. The reactor system of claim 22, wherein the reactor unit includes a plenum capable of removing liquids from the reactor vessels.

27. The reactor system of claim 22, wherein the reactor unit includes a robotic shaker capable of shaking the reactor vessels and returning to a reset position.

28. The reactor system of claim 22, wherein the injection unit includes a plurality of syringes, each syringe capable of holding a different reagent.

29. The reactor system of claim 28, wherein several syringes hold the same reagent.

30. The reactor system of claim 28, wherein the injection unit further includes a drive system operable to pump the syringes and configurable to do so in multiple increments.

31. The reactor system of claim 28, wherein the injection unit includes a plurality of valves connecting the syringes to a plurality of reagent lines.

32. The reactor system of claim 22, wherein the plurality of reactions include an oxidation reaction in the presence of a heterogeneous catalyst in the liquid phase.

33. A parallel reactor for use in a system adapted to carry out a plurality of reactions simultaneously, comprising:
a plurality of reactor vessels for containing a plurality of reaction components;
means for holding the plurality of reactor vessels;
means for injecting a reagent into each reactor vessel; and
means for controlling the injecting means so that the reagents are injected into each reactor vessel in parallel and at the same or substantially the same flow rate.

34. The parallel reactor of claim 33, further comprising means for automatic handling of the reaction components.

35. The parallel reactor of claim 33, further comprising means for synthesizing the reaction components in parallel.

36. The parallel reactor of claim 33, further comprising means for agitating the reaction components.

37. The parallel reactor of claim 33, further comprising means for preparing the reagent.

38. The parallel reactor of claim 33, further comprising means for applying temperature treatment to the reaction components and the reagent.

39. The parallel reactor of claim 33, wherein the plurality of reaction components include heterogeneous catalysts in the liquid phase.

40. A method of conducting a plurality of reactions in parallel, comprising:
placing a plurality of reaction components to be reacted in a plurality of reactor vessels arranged in parallel;
injecting a reagent into the plurality of reactor vessels at the same or substantially the same flow rate; and
maintaining a substantially constant pressure in at least one of the reactor vessels.

41. The method of claim 40, further comprising applying temperature treatment to the reaction components and to the reagent.

42. The method of claim 40, further comprising synthesizing the reaction components in parallel.

43. The method of claim 40, wherein the injecting step is performed in multiple increments.

44. The method of claim 40, further comprising removing unwanted material resulting from the plurality of reactions.

45. The method of claim 44, further comprising selecting between either the injecting step or the removal step to be performed.

46. The method of claim 40, wherein a different reagent is injected into each reactor vessel.

47. The method of claim 40, wherein the same reagent is injected into several reactor vessels.

48. The method of claim 40, wherein the reaction components include heterogeneous catalysts in the liquid phase.

49. A method of preparing reagent mixtures in parallel, comprising:
simultaneously expanding a plurality of syringes to a first volume;
filling the first volume of each syringe with a first reagent;
simultaneously expanding the plurality of syringes to a second volume; and
filling the second volume of each syringe with a desired reagent.

50. The method of claim 49, wherein the desired reagent is the same as the first reagent.

51. The method of claim 49, wherein the desired reagent is different from the first reagent.

52. The method of claim 49, wherein the second volume is substantially the same as the first volume.

53. The method of claim 49, wherein the second volume is different from the first volume.

54. A parallel reactor for use in a system adapted to carry out a plurality of reactions simultaneously, comprising:
a plurality of reactor vessels, each reactor vessel capable of maintaining a substantially constant pressure therein during a reaction and having a transfer line connected thereto;
a selector valve connected to each reactor vessel via a respective transfer line;
a delivery line and a removal line connected to each selector valve; and
valve actuators in each selector valve, the valve actuators are controllable to selectively open the transfer line to either the delivery line or the removal line.

55. The parallel reactor of claim 54, further comprising a heating zone and a cooling zone operable to heat and cool the reactor vessels, respectively.

56. The parallel reactor of claim 54, further comprising a substrate having threaded bores formed therein.

57. The parallel reactor of claim 56, further comprising an elastomeric ring disposed in each of the threaded bores between the substrate and the reactor vessels.

58. The parallel reactor of claim 54, further comprising a robotic shaker operable to shake the reactor vessels and configurable to return to a reset position.

59. The parallel reactor of claim 54, wherein each reactor vessel includes a mouth portion that is open to the surrounding environment.

60. The parallel reactor of claim 54, wherein each reactor vessel includes a neck portion having threads thereon.

61. The parallel reactor of claim 60, wherein the neck portion of each reactor vessel includes a gas permeable filter integrally formed therein.

62. The parallel reactor of claim 60, wherein the neck portion of each reactor vessel includes a removable gas permeable filter disposed therein.

63. The parallel reactor of claim 62, wherein the removable gas permeable filter is sandwiched between a pair of elastomeric O-rings.

64. The reactor system of claim 60, wherein the neck portion of each reactor vessel has a removable gas permeable filter and an elastomeric O-ring disposed thereunder.

65. An injection system for a plurality of reactor vessels, comprising:
a plurality of syringe pumps, each syringe pump adapted to hold a reagent therein;
a drive system operatively attached to the plurality of syringe pumps;
a control valve connected to each syringe pump and controllable to open either a delivery line or a supply line connected to the syringe pump;
a supply valve attached to each syringe pump and controllable to open the syringe pump to one of a plurality of reagent lines;
a control unit connected to and configured to control the drive system to pump the syringe pumps to deliver the reagents therein to the reactor vessels at the same or substantially the same flow rate.

66. The injection system of claim 65, wherein each syringe pump contains a different reagent.

67. The injection system of claim 65, wherein several syringe pumps contain the same reagent.

68. The injection system of claim 65, wherein the drive system includes a syringe plate, and each syringe pump includes a plunger slidingly engaged therewith and attached to the syringe plate.

69. The injection system of claim 65 wherein the control unit includes a processor unit and a data storage unit, the data storage unit storing instructions for instructing the processor unit to:
(a) expand the syringe pumps to a predefined volume;
(b) fill the syringe pumps with a desired reagent;
(c) open a flow path between the syringe pumps and the reactor vessels;
(d) compress the syringe pumps in parallel; and
(e) close the flow path between the syringe pumps and the reactor vessels.

70. The injection system of claim 69, wherein instructions (a)-(b) are repeated one or more times before instructions (c)-(e) are executed.
